(19) United States
(12) Patent Application Publication
(10) Pub. No.: US 2007/0177458 A1
(43) Pub. Date: Aug. 2, 2007

(54) Method for mixing fluid streams, microfluidic mixer and microfluidic chip utilizing same

(75) Inventors: Jens-Christian Meiners, Saline, MI (US); Hao Chen, Ann Arbor, MI (US)

Correspondence Address: BROOKS KUSHMAN P.C., 1000 TOWN CENTER, TWENTY-SECOND FLOOR, SOUTHFIELD, MI, 48075, US

(73) Assignee: THE REGENTS OF THE UNIVERSITY OF MICHIGAN, Ann Harbor, MI (US)

(21) Appl. No.: 10/596,706

(22) PCT Filed: Dec. 22, 2004
(86) PCT No.: PCT/US04/43152

§ 371 Date: Apr. 3, 2007

Related U.S. Application Data
(60) Provisional application No. 60/532,157, filed on Dec. 23, 2003.

(51) Int. Cl. B01F 5/06

(52) U.S. Cl. 366/336; 366/340

(57) ABSTRACT

A method for mixing fluid streams, microfluidic mixer and microfluidic chip utilizing same utilize a topological mixing scheme that exploits the laminarity of the flow to repeatedly fold the flow and exponentially increase the concentration gradients to obtain fast and efficient mixing by diffusion (FIG. 1a). It is based on helical flow channels with opposite chiralities that split rotate and recombine the fluid stream in a topology reminiscent of a series of MÖBIUS bands. This geometry is realized in a simple six-stage, two-layer elastomer structure with a footprint of 400 μm×300 μm per stage that mixes two solutions efficiently at Reynolds numbers between 0.1 and 2. This represents more than an order of magnitude reduction in the size of microfluid mixers that can be manufactured in standard multilayer soft lithography techniques.

### CROSS-REFERENCE TO RELATED APPLICATION

This application claims the benefit of U.S. provisional application Ser. No. 60/532,157, filed Dec. 23, 2003.

### STATEMENT REGARDING FEDERALLY SPONSORED RESEARCH OR DEVELOPMENT

The invention was made with Government support under NIH Grant No. GM 65934-01. The Government has certain rights to the invention.

### BACKGROUND OF THE INVENTION

1. Field of the Invention

The present invention is directed to methods for mixing fluid streams, microfluidic mixer and microfluidic chip utilizing same.

2. Background Art

The following are referred to hereinbelow:

[1] M. A. Unger et al., SCIENCE 288, 113 (2000).

[2] T. Thorsen et al., SCIENCE 298, 580 (2002).

[3] J. Liu et al., ELECTROPHORESIS 23, 1531 (2002).

[4] A. D. Stroock et al., SCIENCE 295, 647 (2002).

[5] R. H. Liu et al., MICROELECTROMECH. SYST. 9, 190 (2000).

[6] D. Therriault et al., NAT. MATER. 2, 265 (2003).

[7] F. G. Besoth et al., ANAL. COMMUN. 36, 213 (1999).

[8] V. Hessel et al., AICHE J. 49, 566 (2003).

[9] S. K. W. Dertinger et al., ANAL. CHEM. 73, 1240 (2001).

[10] D. C. Duffy et al., ANAL. CHEM. 70, 4974 (1998).

[11] H. Chen et al., ANAL. CHEM. 75, 5287 (2003).

[12] H. Song et al., ANGEW. CHEM., Int. Ed. 42, 768 (2003).

Microfluidic devices and system are becoming increasingly popular for applications all across the life sciences. Multilayer soft lithography has attracted particular attention because it allows not only inexpensive large-scale production of microfluidic chips from replication molds, but also the incorporation of active elements such as pumps and valves on the chip [1]. With the ever-shrinking dimensions of microfluidic components, a remarkably large scale of integration can be achieved.

Recently, Thorsen et al. [2] demonstrated a multiplexer with 1000 sample cells that are accessed through 3574 valves on a single chip. Despite these advances toward a highly integrated lab on-a-chip, one key component has proven very difficult to miniaturize: the fluidic mixer. The principal obstacle is that at typical microfluidic dimensions (l=100 μm feature size) and flow rates (v=1 mm/s) the Reynolds number Re=lρv/η=0.1 for an aqueous solution (density ρ=1 g/cm³, viscosity η=0.001 Nsm²) is so low that all flow is laminar and turbulence cannot be achieved.

Diffuision, on the other hand, is too slow to be effective. In order to mix two protein solutions with a diffusion coefficient D=2×10⁻¹¹ m²/s at the flow parameters above, a channel length l_{c}=0.5 vl²/D of 25 cm is required.

To overcome this difficulty and achieve mixing on length scales compatible with microfluidic designs, several schemes have been proposed. Active 25 mixers pump the fluid repeatedly around a circular path [3], whereas chaotic flow mixers stretch and fold the fluid flow laterally to obtain an exponential decrease in the size of the concentration inhomogeneities with channel length [4]. Examples for such chaotic mixers are stirring in helical microchannels [5] and chaotic flow in microchannels with herringbone relief structures on the bottom wall [4]. The helical channels require atypically high Reynolds numbers (Re>10) to be effective, whereas the latter is relatively inefficient at inducing a lateral flow and still requires channel lengths on the order of centimeters for efficient mixing. To reduce the footprint of such a mixer, Therriault et al. [6] have introduced a three-dimensional vascular network of flow channels. Their 16-layer structure has a lateral size of 2 mm×2 mm, but due to its vertical complexity, is rather difficult to manufacture.

In a different approach, an array of microfabricated nozzles is used to create a layered stream to reduce the effective length scale for diffusing mixing [7-9]. This flow laminating technique requires typically one microfluidic element for each boundary layer that is created. Thus, the required channel length for efficient mixing decreases only quadratically with the number of fluid-manipulating elements, and not exponentially as in the case of chaotic mixers.

### SUMMARY OF THE INVENTION

An object of the present invention is to provide a method for mixing fluid streams, microfluidic mixer and microfluidic chip utilizing same wherein the mixing can occur in a very small space.

In carrying out the above object and other objects of the present invention, a method for mixing fluid streams within a combined fluid stream having a concentration profile is provided. The method includes: a) splitting the combined fluid stream into separate fluid streams; b) rotating the separate fluid streams relative to each other so that the concentration profile is also relatively rotated; c) recombining the separate fluid streams wherein the recombined fluid stream has a folded over concentration profile and an increased concentration gradient; and repeating steps a, b and c until the fluid streams are mixed to a desired extent.

Step b may rotate the fluid streams in opposite directions.

The concentration gradient may be increased exponentially.

The fluid streams may be mixed by diffusion.

The fluid streams may be rotated in a helical fashion.

The fluid streams may be mixed at Reynolds numbers between 0.1 and 2.

Further in carrying out the above object and other objects of the present invention, a microfluidic mixer for mixing fluid streams within a combined fluid stream having a concentration profile is provided. The mixer includes a plurality of separate microfluidic channels for splitting the combined fluid stream into separate fluid streams, rotating the separate fluid streams and recombining the separate fluid streams to obtain a recombined fluid stream. The microfluidic channels rotate the fluid streams relative to each other so that the concentration profile is also relatively rotated. The concentration profile of the recombined fluid stream is folded over so that the concentration gradient is increased.

The channels may rotate the fluid streams in opposite directions.

The concentration gradient may be increased exponentially.

The fluid streams may be mixed by diffusion.

The fluid streams may be rotated in a helical fashion.

The fluid streams may be mixed at Reynolds numbers between 0.1 and 2.

At least one of the separate microfluidic channels may have a substantially square cross-section.

Still further in carrying out the above object and other objects of the present invention, a microfluidic chip is provided. The chip includes a substrate and a microfluidic mixer supported on the substrate for mixing fluid streams within a combined fluid stream having a concentration profile. The mixer includes a plurality of separate microfluidic channels for splitting the combined fluid stream into separate fluid streams, rotating the separate fluid streams relative to each other so that the concentration profile is also relatively rotated and recombining the separate fluid streams to obtain a recombined fluid stream having a folded over concentration profile and an increased concentration gradient.

The channels may rotate the fluid streams in opposite directions.

The concentration gradient may be increased exponentially.

The fluid streams may be mixed by diffusion.

The fluid streams may be rotated in a helical fashion.

The fluid streams may be mixed at Reynolds numbers between 0.1 and 2.

At least one of the separate microfluidic channels may have a substantially square cross-section.

The above object and other objects, features, and advantages of the present invention are readily apparent from the following detailed description of the best mode for carrying out the invention when taken in connection with the accompanying drawings.

### BRIEF DESCRIPTION OF THE DRAWINGS

FIG. 1a is a schematic perspective view of a topologic structure for microfluidic mixing, two different protein solutions are combined in a T-junction; the fluid flow is repeatedly split, rotated and recombined as indicated by the arrows;

FIG. 1b is a schematic perspective view which illustrates the realization of the mixer in a two-layer planar geometry using two replication-molded slabs of a silicone elastomer; the two layers are sandwiched and fused together to form a hermetic seal;

FIG. 1c is a schematic cross-sectional view of an assembled mixing chip; the two principal elastomer layers with the flow channels are anchored with a third layer to the microscope cover slip; stainless steel tubes are inserted to deliver the reagents to the chip, and the entire chip is encapsulated in a block of transparent epoxy resin to provide mechanical stability and convenient mounting;

FIG. 2a illustrates mixing of two fluorescently-labeled protein solutions in a six-stage mixer at a flow rate of 1 mm/s, corresponding to a Reynolds number of 0.1;

FIG. 2b illustrates mixing of the same dyes in an aqueous 54% glycerol solution with ten-fold higher viscosity at a flow rate of 10 mm/s, maintaining the same Reynolds number of 0.1; and

FIG. 3 is a schematic view of an in-line mixer that can be fabricated as two injection-molded pieces that may be fused together.

### DETAILED DESCRIPTION OF THE PREFERRED EMBODIMENTS

In general, the present invention provides methods for mixing fluid streams, microfluidic mixers and microfluidic chips utilizing same. The invention may be implemented in a topological structure that exploits the laminarity of the flow to repeatedly fold the flow and double the lateral concentration gradient deterministically in a very compact geometry. Unlike a conventional laminar mixer that adds one boundary layer per microfluidic element to the stream, the present topology performs a series of Baker's transformations on the concentration profile. This creates a layered fluid stream in a process that decreases the required channel length exponentially with the number of microfluidic elements on the chip. The resultant exponential decrease in the size of the inhomogeneities is the same as for the chaotic mixers; but efficient mixing can be achieved with channel lengths on the order of millimeters.

The present scheme uses a series of microfluidic elements (splitters, turns, combiners) that retain the concentration profile across the channel. The flow may be split into two identical streams, and through a series of turns, rotate the concentration profile by π/2 in opposite directions in each channel. Upon recombination, the concentration pattern and gradients are doubled. The basic topologic structure to achieve this is somewhat akin to a Mobius band: A surface vector on the band, or here, the concentration gradient vector in the flow channel, is rotated in a different direction depending on the chirality of the chosen path, even though they start at and reach the same locations.

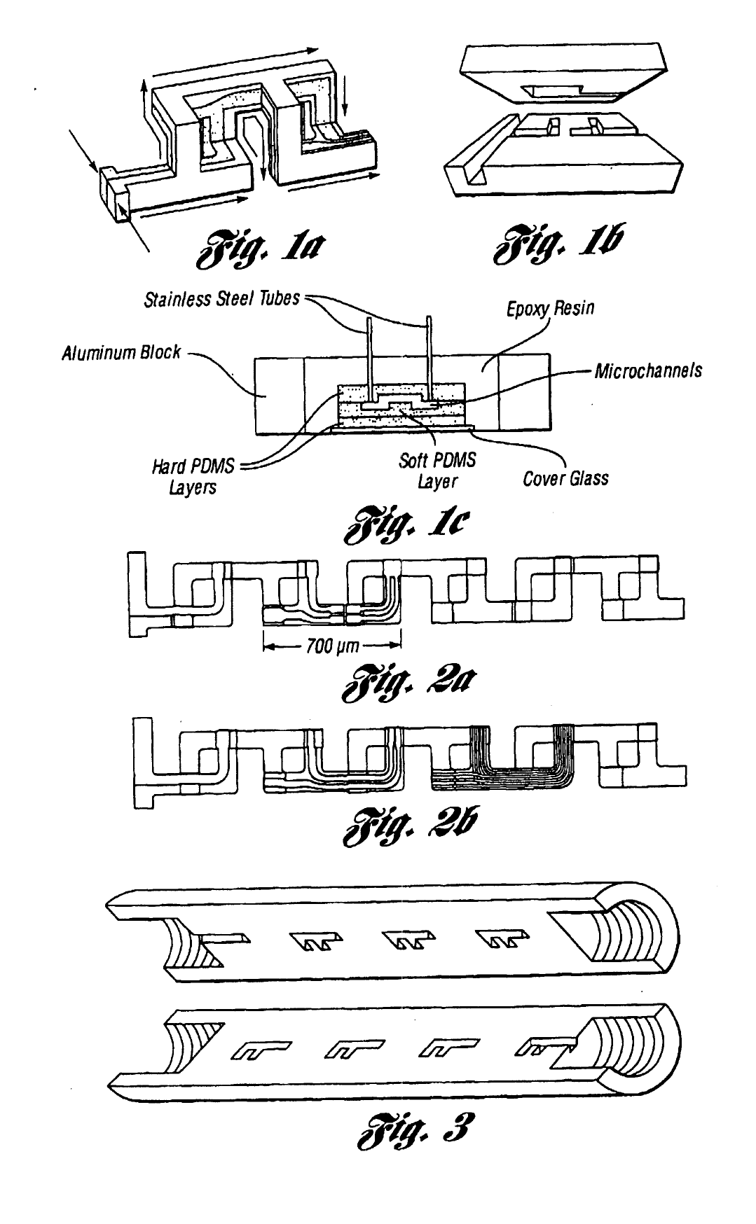

FIG. 1a shows a realization of this topology: the two fluid streams are combined, split out-of-plane, rotated in opposite directions, and recombined, folding over the concentration profile and doubling the lateral gradient. A subsequent similar stage doubles the gradient once more and returns the fluid stream to the original plane.

As such a truly three-dimensional structure is hard to manufacture, the design is simplified by eliminating the straight out-of-plane runs. The design may use two planar layers that are sandwiched and fused together, as shown in the cross-sections of FIGS. 1b and 1c. Sufficient out-of-plane rotation is obtained where the channels in the different layers overlap, as long as the cross-section of the channels is sufficiently square. The channels may be 100 μm wide and 70 μm deep, and each stage of the mixer has a footprint of 400 μm×300 μm.

The microfluidic chips are fabricated by replication molding of a silicone elastomer (RTV 615 A and B, General Electric, Waterford, N.Y.) from a master mold. The master molds are manufactured using a rapid-prototyping approach [10], in which a 70 μm thick layer of patterned photoresist (SU-8, 2050, Micro-Chem NANO™, Newton, Mass.) serves directly as the mold for the elastomer. The top layer was cast as a slab of 4-5 mm thickness from a 4:1 mixture of RTV 615 A and B, whereas the bottom layer was spin-cast to a thickness of 90 μm from a 25:1 mixture of the two RTV compounds. After curing, both layers were sandwiched together under a stereomicroscope, and stainless steel tubing was inserted to provide inlets and outlets for the fluids. The elastomer chip was then anchored on a microscope cover glass. To insulate the chip from mechanical strain from the external mounting or tubing, which causes fluctuations in the flow rates as the channels expand or contract, the chip can be encapsulated in a block of epoxy resin [11] (Tra-bond 2115, Tra-Con Inc., Bedford, Mass.). A cross-section of the entire chip assembly is shown in FIG. 1c.

To demonstrate mixing of two protein solutions on the chip, the chip is mounted on an inverted optical microscope. Two kinds of fluorescently-labeled streptavidin (Streptavidin AlexaFluor488 and Streptaviden AlexaFluor568, Molecular Probes) were dissolved at a concentration of 1 mg/ml in PBS (8 mM NAPO₄, 1.5 mM KHPO₄, 2.7 mM KCl, 130 mM NaCl, pH 7.3) and injected into the flow channels with syringe pumps at flow rates of 15 μl/hr each. The fluorescence was imaged onto a commercial color charge-coupled device camera using a two-color fluorescence filter set (FITC/Texas Red, Chroma Technology, Rockingham, Vt.).

FIGS. 2a and 2b show the mixing of the two fluorescently-labeled protein solutions in a six-stage mixer. Initially, the fluids are combined in a T-junction, exhibiting one sharp boundary layer. After the first two mixing stages, four interfaces, now broadened by diffusion. After three stages or a device length of 1.2 mm, the liquids are well mixed. Under the present conditions, the Reynolds number and Peclet numbers are Re=0.1, and Pe=0.69, respectively, which indicates that diffusion is the dominant mixing process at the interfaces. By increasing the viscosity of the solution and increasing the flow rate, one can slow down and decrease the efficiency of diffusion while maintaining a Reynolds number of Re=0.1. The second micrograph in FIG. 2b shows the mixing of the same fluorescent dyes at ten-fold higher viscosity and flow rate. Whereas the channel length required for purely diffusive mixing in a linear channel in this scenario increases hundred-fold, the present mixer obtains efficient mixing after five stages, or an approximate doubling of the device length due to the favorable exponential scaling of the topologic scheme.

To quantify the performance of the present mixer, a Ca²⁺ sensitive dye (Fluo-4, Molecular Probes) was mixed with a CaCl₂ solution on the hcipo and used the resultant increase in fluorescence to determine the degree to which thre solutions are mixed [12]. The dye and the CaCl₂ were dissolved in morpholino propanesulfonate buffer (20 mM, pH 7.2) at concentrations of 54 and 70 μM, respectively. Fluorescence images of the mixing fluid streams were captured at various stages of the mixer at Reynolds numbers ranging from 0.1 to 2. The fluorescence background of the dye alone was determined from a premixed solution of the dye and a Ca²⁺-free buffer, and subtracted before the net increase in fluorescence due to mixing was determined by integration. Comparison with a Ca²⁺-activated reference solution, which was mixed before it was introduced into the chip, yields a measure for the remaining unmixed fluid volume at each stage of the mixer. The result indicates that this unmixed volume indeed decreases exponentially with the number of mixing stages, or equivalently, channel length, for the entire range of flow velocities ranging from Re=0.1 to Re=2, and Pe=0.69 Pe=13.9.

Referring now to FIG. 3, there is illustrated an in-line mixer that may be inserted into a fluidic line to ensure that anything that flows through it is well-mixed. As it uses only laminar flow, this device would work independent of flow rate and avoid problems with bubble formation of dissolved gasses, etc. All dimension are of the dimension of the microbore tubing that is used to transport the fluids to the chromatography system, so there are no smaller features that could clog easily. Also, the shear rates are generally very low, reducing the risk of protein denaturization or breakage of long DNA pieces. The in-line mixer could be fabricated as two injection-molded pieces as illustrated in FIG. 3 that are fused together.

Similarly, a special mixing T or Y could be made that has two inlets, combines the two streams, and then mixes them.

As described above, effective microfluidic mixing can be achieved on short lengths scales with a purely laminar flow through a flow-folding topologic structure. Favorable scaling laws ensure efficient mixing even under unfavorable conditions, such as a high molecular weight or high viscosity. While the topologic principle behind the mixer is independent of the chosen microfluidic platform technology, it has been shown that an efficient device can be readily manufactured by standard planar multilayer soft lithographic techniques.

In summary, it has now been surprisingly discovered that microfluidic channels containing a plurality of separate coflowing streams of fluid may be effectively mixed over relatively short distances by dividing the common channel through which they flow into a plurality of channels, and directing the divided plurality of channels in space in such a manner that a relative rotation of the fluid in the channels relative to other divided channels is achieved, and then recombining a plurality of channels into a combined channel. By repeating the division and rotation, further mixing can be obtained. Furthermore, the lineal space required for mixing is relatively small, and thus the small size desired of microfluidic devices can be maintained. Efficient and cost-effective construction is achieved by employing two-layer or multi-layer devices, where each layer may be constructed by conventional techniques.

The relative degree of rotation of each of two streams flowing in a single channel is preferably π/2, and the division of the channel need not be an even division, i.e. a single channel may be divided into two channels, one having, for example, one third the lineal volume (i.e. cross-sectional area) of the original channel while the other channel has two thirds the lineal volume. The cross-sectional area division, when two divided streams are created, is advantageously lower than 9:1, more preferably lower than 4:1, and most preferably lower than 3:2. An even split is also satisfactory.

One or both streams may be caused to rotate prior to recombination, preferably both streams. When multiple division, rotation, and recombination stages are employed, each stage may provide for the same amount of rotation or different amounts of rotation. The references cited herein are herein incorporated by reference.

The subject invention further pertains to a method of mixing fluids flowing in a microfluidic channel, comprising dividing the channel into a plurality of divided channels, each having flowing therein a portion of the fluids flowing in the original channel, causing the fluid in at least one channel to be rotated other than 360° from at least one other channel, and reuniting the divided channels into a recombined channel. The rotation of the fluids is caused by a changing direction of the channels in space, rather than active mixing devices.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method for mixing fluid streams within a combined fluid stream having a concentration profile, the method comprising:
a) splitting the combined fluid stream into separate fluid streams;
b) rotating the separate fluid streams relative to each other so that the concentration profile is also relatively rotated;
c) recombining the separate fluid streams wherein the recombined fluid stream has a folded over concentration profile and an increased concentration gradient; and
repeating steps a, b and c until the fluid streams are mixed to a desired extent.

2. The method as claimed in claim 1, wherein step b rotates the fluid streams in opposite directions.

3. The method as claimed in claim 1, wherein the concentration gradient is increased exponentially.

4. The method as claimed in claim 1, wherein the fluid streams are mixed by diffusion.

5. The method as claimed in claim 1, wherein the fluid streams are rotated in a helical fashion.

6. The method as claimed in claim 1, wherein the two fluid streams are mixed at Reynolds numbers between 0.1 and 2.

7. A microfluidic mixer for mixing fluid streams within a combined fluid stream having a concentration profile, the mixer comprising:
a plurality of separate microfluidic channels for splitting the combined fluid stream into separate fluid streams, rotating the separate fluid streams and recombining the separate fluid streams to obtain a recombined fluid stream, wherein the microfluidic channels rotate the fluid streams relative to each other so that the concentration profile is also relatively rotated wherein the concentration profile of the recombined fluid stream is folded over so that the concentration gradient is increased.

8. The mixer as claimed in claim 7, wherein the channels rotate the fluid streams in opposite directions.

9. The mixer as claimed in claim 7, wherein the concentration gradient is increased exponentially.

10. The mixer as claimed in claim 7, wherein the fluid streams are mixed by diffusion.

11. The mixer as claimed in claim 7, wherein the fluid streams are rotated in a helical fashion.

12. The mixer as claimed in claim 7, wherein the two fluid streams are mixed at Reynolds numbers between 0.1 and 2.

13. The mixer as claimed in claim 7, wherein at least one of the separate microfluidic channels has a substantially square cross-section.

14. A microfluidic chip comprising:
a substrate; and
a microfluidic mixer supported on the substrate for mixing fluid streams within a combined fluid stream having a concentration profile, the mixer including a plurality of separate microfluidic channels for splitting the combined fluid stream into separate fluid streams, rotating the separate fluid streams relative to each other so that the concentration profile is also relatively rotated and recombining the separate fluid streams to obtain a recombined fluid stream having a folded over concentration profile and an increased concentration gradient.

15. The chip as claimed in claim 14, wherein the channels rotate the fluid streams in opposite directions.

16. The chip as claimed in claim 14, wherein the concentration gradient is increased exponentially.

17. The chip as claimed in claim 14, wherein the fluid streams are mixed by diffusion.

18. The chip as claimed in claim 14, wherein the fluid streams are rotated in a helical fashion.

19. The chip as claimed in claim 14, wherein the fluid streams are mixed at Reynolds numbers between 0.1 and 2.

20. The chip as claimed in claim 14, wherein at least one of the separate microfluidic channels has a substantially square cross-section.
